(19) United States
(12) Patent Application Publication
(10) Pub. No.: US 2014/0124074 A1
(43) Pub. Date: May 8, 2014

(54) BLAST RESISTANT PIPE PROTECTION SYSTEM AND METHOD

(71) Applicant: James Jackson Milham Henry, Houston, TX (US)

(72) Inventor: James Jackson Milham Henry, Houston, TX (US)

(73) Assignee: ROK INVESTMENT GROUP LIMITED, Albrighton, West Midlands (GB)

(21) Appl. No.: 14/128,617

(22) PCT Filed: Jun. 25, 2012
(86) PCT No.: PCT/US2012/044048

§ 371 Date: Dec. 22, 2013

Related U.S. Application Data
(60) Provisional application No. 61/500,530, filed on Jun. 23, 2011.

(51) Int. Cl. F16L 57/00

(52) U.S. Cl. CPC F16L 57/00
USPC 138/103

(57) ABSTRACT

The present invention is directed to generally to protection of structures from explosives, and specifically to a blast resistant pipe protection system and method for using same. The present invention is directed to a system and method for protecting a pipe. In some embodiments, the present invention is directed to a system for protecting a pipe, comprising an energy absorbing inner matrix bound to the pipe; an outer wrap comprising fire resistant foil; and a blast resistant material disposed between the inner matrix and the outer wrap, wherein the blast resistant material comprises Purlite. In some embodiments, the present invention is directed to a method for protecting a pipe comprises binding an energy absorbing inner matrix to the pipe; disposing Purlite around the inner matrix; and wrapping the Purlite with fire resistant foil.

### CROSS-REFERENCE TO RELATED APPLICATIONS

This Application for Patent claims priority to U.S. Provisional Patent Application Ser. No. 61/500530, filed Jun. 23, 2011.

### FIELD OF THE INVENTION

The present invention relates generally to protection of structures from explosives, and specifically to a blast resistant pipe protection system and method for using same.

### BACKGROUND OF THE INVENTION

According to the U.S. Government's security agency, TSA, there are 161,189 miles of hazardous liquid pipelines and 309,503 miles of Natural Gas pipelines and 1.9 million miles of Natural Gas distribution lines in the U.S. America's enemies have concluded that the most effective way to accomplish their avowed goals of destroying our economic base and target the most vulnerable targets that could effect the greatest disruption to the U.S. economy, would involve attacks to our energy transmission pipelines. The history of man made systems that can or might offer some form of explosive and/or bomb blast protection to critical pipelines that can or might carry flammable liquid or gaseous compounds is based on relatively recent new requirements.

Prior to the 2001 attacks on the World Trade Center in New York, worldwide attention on energy security, in this case, specifically pipeline security, was extremely limited. One group that has been a seemingly lone voice in the wilderness is IAGS [Institute for Global Security] located in Washington D.C. Groups such as IAGS and others have been warning the world's energy producers and energy consumers of the growing sophistication, abilities and focused intent of the various terrorist groups throughout the world to target and disrupt energy supplies. In particular, many terrorist groups have increasingly realized that attacks against pipelines, oil storage facilities, oceangoing tankers, and even trucks that haul fuel stocks, are the

Achilles Heel in western civilization. The U.S. Government's agency, TSA [www.tsa.gov/what_we_do/tsnm/ pipeline.shtm], generally speaking, offers security analysis to pipeline operators through advisory links, but predominantly offers advise on how and where to attend TSA conducted security seminars.

Security firms around the world predominantly use electronic surveillance systems. Security firms such as, but not limited to, the British firm, Westminster International Ltd. [www.wi-ltd.com], and FTP Secure Solutions [www.ftpemea.com], offer CCTV TV surveillance, satellite monitoring and sophisticated sound and IR (infrared) observance technology.

The GSA and other U.S. Government agencies such as TSA (tasked by current charter to protect pipelines within the Continental U.S.), point to very few technologies in the world that can be applied in a physical manner to protect pipelines. Other security firms offer concrete mesh wraps such as, but limited to, Beticrete [www.beticrete.com]. Blast suppression technology from companies such as, but not limited to, TechnoKontrol Ltd. [www.technokontrol.com], are based on a well known principle B.L.E.V.E. (acronym for Boiling Liquid Expanding Vapor Explosive). This blast principle is similar to the military's development of fuel-air bombs. The effect works by heating and atomizing liquid fuel into a vapor and then providing and ignition source (bomb in this case).

Products such as, but not limited to, “reticulated foams” that keep liquid fuels isolated into thousands of small open cell pockets, or in the case of TechnoKontrol Ltd., using metal foams instead of polyurethane foams, accomplish the same or similar effect. It is an effective technology, especially for stationary storage tanks, and military fuel tanks on aircraft, armored vehicles, trains, etc. It is not as effective at physically protecting a pipeline from a close proximity explosive attack, due to the simple fact that the pipeline still gets deformed and/or penetrated.

Thus, there remains a need for practical, commercially available, independent outside lab proven, and most importantly, cost effective, pipeline blast and explosion protection systems. It would be desirable to have a system that leaves the pipeline unbreached and intact, post blast, not merely just trying to prevent the leaking fuel from exploding as it runs out into the environment.

### BRIEF DESCRIPTION OF THE INVENTION

The present invention is directed to a system and method for protecting a pipe. The system and methods are suitable for protecting over or under land transmission pipelines and for protecting building utility pipes.

In some embodiments, the present invention is directed to a system for protecting a pipe, comprising an energy absorbing inner matrix bound to the pipe; an outer wrap comprising fire resistant foil; and a blast resistant material disposed between the inner matrix and the outer wrap, wherein the blast resistant material comprises Purlite. In some embodiments, the Purlite is contained in a plurality of bags. The bags may be are arrayed circumferentially around the pipe.

According to some embodiments, the energy absorbing inner matrix comprises a polymeric annulus; and a pair of fiberglass half-pipes disposed over the annulus. According to some embodiments, the polymeric annulus comprises first and second polymers. The first polymer may comprise urethane foam. The second polymer may comprise reticulated foam. According to some embodiments, the annulus comprises an inner annulus comprising the first polymer and a second annulus comprising the second polymer. Thee second annulus may further comprise a third polymer soaked into the second polymer. According to some embodiments, the first polymer comprises urethane foam, the second polymer comprises reticulated foam, and the third polymer comprises urethane. According to some embodiments, the polymeric annulus is formed in situ under the fiberglass half-pipes, after the fiberglass half-pipes are disposed over the pipe. According to some embodiments, the inner matrix comprises one or more of the following additional components: a blast resistant window film; a ballistic film; steel wire; and a clamp. The additional components may be disposed in that order around the pair of fiberglass half-pipes.

It will be understood that the above-described embodiments may be used singly or in combination. Thus, for example, according to some embodiments, a system for protecting a pipe comprises an energy absorbing inner matrix bound to the pipe; an outer wrap comprising fire resistant foil; and a blast resistant material disposed between the inner matrix and the outer wrap; wherein the blast resistant material comprises a Purlite contained in a plurality of bags arranged circumferentially around the pipe, wherein the energy absorbing inner matrix comprises a first annulus comprising urethane foam; a second annulus disposed around the first annulus, the second annulus comprising reticulating foamed soaked in urethane; a pair of fiberglass half-pipes disposed over the second annulus; a blast resistant window film disposed over the half-pipes; a ballistic film disposed over the blast resistant window film; steel wire disposed over the ballistic film; and a clamp.

According to some embodiments, a method for protecting a pipe comprises binding an energy absorbing inner matrix to the pipe; disposing Purlite around the inner matrix; and wrapping the Purlite with fire resistant foil. The disposing may comprise providing the Purlite in a plurality of bags. The providing comprises arranging the bags circumferentially around the pipe. The binding may comprise disposing one or more of the above-described parts of the energy absorbing inner matrix around the pipe.

The system and method provide blast resistance to at least about 50 pounds of TNT at about 10 feet distance.

The foregoing has outlined rather broadly the features of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a cross-sectional view of a blast resistant system for protecting a pipe;

FIG. 2 is a perspective view of the system shown in FIG. 1;

FIG. 3 is a plot of pressure and impulse as a function of time in an experimental test with about 50 pounds of ANFO at about 10 feet; and

FIG. 4 is a plot of pressure and impulse as a function of time in an experimental test with 25 pounds of ANFO at about 10 feet.

### DETAILED DESCRIPTION OF THE INVENTION

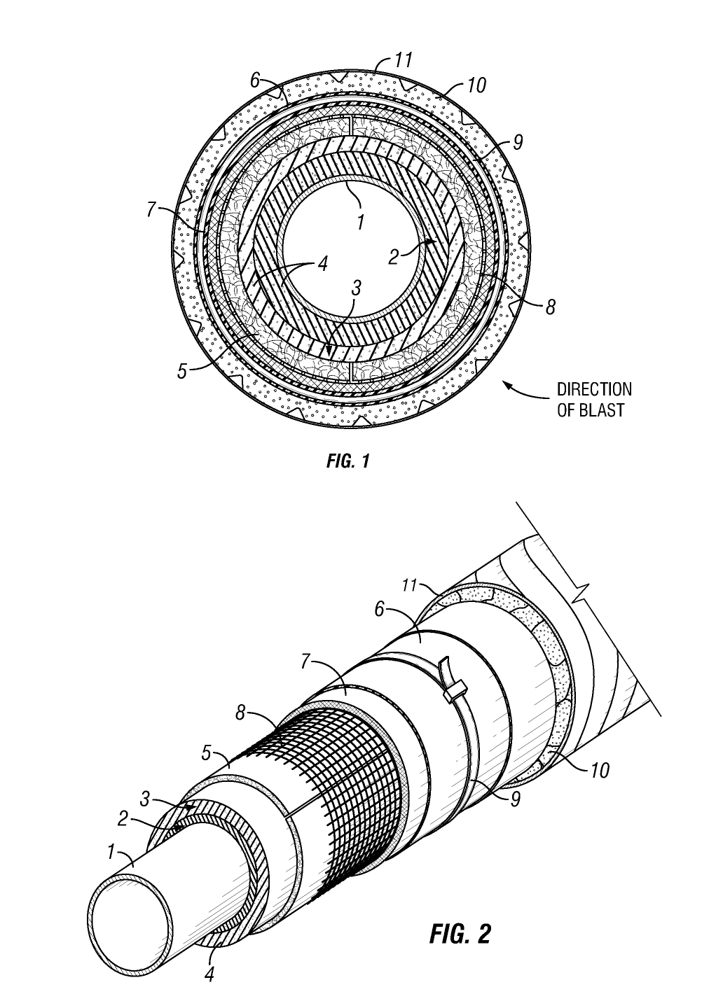

The present invention is directed to a blast resistant system and method for protecting a pipe. Generally, a system for protecting a pipe, comprising an energy absorbing inner matrix bound to the pipe; an outer wrap comprising fire resistant foil; and a blast resistant material disposed between the inner matrix and the outer wrap, wherein the blast resistant material comprises Purlite. Specifically, Referring to FIGS. 1 and 2, these diagrams show a specific layout of the BLAST-BLOCK technology and layering system.

Referring to FIGS. 1 and 2, according to some embodiments, BLAST-BLOCK PIPE LINE PROTECTION SYSTEM forms a pipe jacket assembly starting at the base of the steel or plastic pipeline is as follows: pipe 1; first annulus 2; second annulus 3, optionally including polymer 4; pipe-halves 5; blast resistant window film 6; ballistic film 7; wire 8; clamp 9; Purlite 10; and fire resistant foil 11.

Pipe 1 can vary from 6″OD (outer diameter) to 36.″00 or 48.″00 or greater OD depending on client requirements. For example, according to some embodiments, the pipe has an inner diameter of 6″ and an outer diameter of 7″. The pipe may be steel. Alternatively, the pipe may be plastic.

First annulus 2 may include a first polymer. The first polymer may be 3 pound expanding urethane foam by, for example, Industrial Polymers of Houston, Tex.

Second annulus 3 may include a second polymer. The second polymer may be reticulating Foam, for example from Houston Foam's. Second annulus 3 may further include third polymer 4. Third polymer 4 may be two part Urethane, for example from Huntsman. Third polymer 4 may be soaked into and absorbed by the reticulating foam.

Half-pipes 5 may be formed of fiberglass, for example Fibrex FRP pipe. Half-pipes 5 may be placed around pipe 1. Fibrex fiber reinforced plastic (FRP) filament wound fiberglass ballistic rated fiberglass. Half-pipes 5 may be formed by splitting one pipe into two halves.

Second annulus 3 may be bonded to half-pipes 5. First annulus 2 and second annulus 3 may be formed in situ, after half-pipes 5 are placed around pipe 1.

Blast resistant window film 6 may be 10 to 20 mil thick. According to some embodiments, blast resistant window film is 15 mil thick. Blast resistant window film may be

Madico or other blast resistant window film. According to some embodiments, blast resistant window film 6 is 15 mil thick Madico film. Overlaps of blast resistant window film 6 face the blast source, that is away from pipe 1.

Ballistic film 7 may be, for example Dyneema HB-26 blast, a ballistic rated UHMPE film (Ultra High Molecular Weight Polyethylene), or other suitable ballistic film. Overlaps of ballistic film 7 face the blast source, that is away from pipe 1.

Wire 8 may be Medium density 12 inch wide super high strength steel wire by HardWire LLC or Sumitomo and other suppliers of super high strength steel wire. According to some embodiments, wire 8 is 3×2 medium density, 12 wpl, 12 inch wide. The wire may cover the entire circumference and length around pipe 1, more particularly around ballistic film. Wire 8 may be Hardwire Composite Armor Systems wire. Overlaps wire 8 face the blast source, that is away from pipe 1.

Clamp 9 may be 19 mm HCL high strength fiber reinforced clamping system (mfg) (19 mm or wider depending on diameter size dimension of the pipeline needing protected). This strapping may be ultra-high strength and clamps all the materials onto the steel or plastic pipeline being protected. It may be placed approximately 18.00″ to 24.00″ apart, the entire length of the pipeline.

Purlite 10 may be Harborlite Purlite 6×10 (expanded) granulated volcanic glass. Purlite 10 may be packaged in 3.00″ to 6.00″ square poly-bags. The bags may be attached circumferentially around pipe 1, more particularly around the pipe array comprising pipe 1, first annulus 2, second annulus 3, pipe-halves 5, blast resistant window film 6, ballistic film 7, wire 8, and clamp 9.

Fire resistant film 11, also termed herein Foil Duct Wrapping, may meet Class A fire codes for building construction. Fire resistant film 11 also serves as a final cosmetic wrap application functions as well to protect Purlite 10 from accidental impacts.

This array of soft materials, such as, but not limited to, the 3 pound expanding foam Ind. Polymers (for example) creates a unique positive, but high impact and energy absorbing shock layer between the steel or plastic pipeline and the next layer of reticulated foam (developed by the military for use as a fuel tank explosion reducing material). The reticulated foam is filled with the soft, two part Huntsman liquid and allowed to set, creating another variation of multiple durometers of energy absorbing harmonic resonance within the structure.

This array of Hard FRP blast and ballistic rated fiberglass from filament winding suppliers such as, but not limited to, Fibrex Inc., or other similar suppliers.

This array of blast and ballistic rated films and steel wires, such as, but not limited to, Madico's 10 to 20 mm thick mylar film, is then overlayed with a layer of Dyneema HB-26 Ballistic UHMPE, then over wrapped further with a layer of HARDWIRE or Sumitomo ultra-high strength steel wire.

All three of these materials have been used in mine resistant vehicles, ballistic resistant body armor, and blast resistant window glass, individually but not necessarily in combination such as the layout described here.

The described array of two different types of polymer based visco-elastic liquid membranes are combined with a reticulated foam. The reticulated foam provides uniform dispersion of the liquid polymers as they cure, and also works symbiotically with the hard FRP Fiberglass to provide a shock absorbing cushion of different durometers, thus creating a change in harmonic resonance and transmitting shock from the blast laterally along the pipeline.

The application of the 19 mm or wider HCL clamping system binds the entire matrix of soft and hard materials to the pipeline.

Finally, the entire matrix is wrapped completely with small bags of packaged Purlite. The critically important issue with Purlite and its use as a blast resistant array, has to do with allowing the packaging to be dispersed in the blast over-pressure event.

But Purlite also must be packaged with enough structure to be suitably robust, to the degree that it can endure casual bumping or other minor non-violent handling.

BLAST-BLOCK is finally wrapped completely in a circumferential wrap with a class A fire resistant foil wrap.

Those skilled in the art of developing explosives and/or who have understanding in testing explosives will know that in order to produce an effective pipeline protection system, one must be able to bring together a myriad of materials to address the numerous issues and requirements to meet the standards issued by a client, whether governmental and or industrial. A number of factors need to be addressed in developing an effective blast resistant system. The system must employ numerous technologies that, at first glance, would appear disparate and unrelated, such as, but not limited to, the following: Many times, engineering firms, as well as government and military experts address typically the over pressure and impulse issues attendant with developing a particular solution to protect vehicles and/or structures from explosives, but might overlook the other issues such as cost, simplicity, ease of installation, and utilizing commercially viable and “commercial off the shelf” (or COTS) materials.

Other issues that must be addressed, which are of equal and/or even greater importance (but many times neglected) in developing a particular anti-terrorism solution, is the requirement of dealing with shrapnel and or flying debris. TNT, for example, when it explodes, can generate an effective brisance (by definition: the shattering ability or speed at which a particular explosive detonates). Those skilled in the art of explosives, blast conflagration and brisance will understand that many times, those persons intent on building bombs and creating maximum damage and fear, will include small metallic objects, such as, but not limited to, nuts and bolts, nails and/or whatever other available hardware that can be placed with the explosives to create casualties and damage. When a particular explosive device is detonated, it can move this shrapnel at a speed approaching upwards of 25,000 feet per second or ten times the speed of a rifle bullet. The only positive thing one might consider in viewing this factor is that bullets are sharp and thus have a very high point load when they come into contact with an object. Shrapnel, on the other hand, is usually irregular in shape, and has considerably lower point loads (flatter, less penetrative properties) upon impact, thus its penetrating energy is lower, even though the velocities are typically higher. Nevertheless, it is critical to address both bomb blast suppression resistance, as well as stopping or resisting small fragmented projectiles.

It is in this area where one must consider a combination of materials that are effective at absorbing over pressure and impulse shock waves. The blast absorbing materials must, of necessity, be tough, yet soft and compliant, whereas materials that will stop, resist, and/or absorb bullets, or high velocity shrapnel or flying debris generated by a bomb blast, must be hard.

There is another material that is not well understood by many of those skilled in the art of bomb blast suppression, and in most cases, do not seem to utilize it and its wondrous properties in an effective manner. That material is called Purlite. Purlite is a naturally occurring volcanic glass with a relatively high water content. When Purlite is heated at high temperature, the water locked in the substrate cells causes the Purlite to expand from 7 to 10 times. Purlite, when tested by the British Ministry of Defense a number of years ago, found that expanded Purlite, when placed next to an explosive, would reduce the fire ball or chemical flame reaction by 90% and the over pressure by 50%. Purlite costs $50.00 per ton and is extremely effective at reducing bomb/explosive blast affects to a considerable degree.

Purlite may absorb bomb blast over-pressure by, at the very least, half the energy of an explosion, even before the other unique combination of hard and soft materials in BLAST-BLOCK are employed in the solution. This experience, along with the rest of the materials used in the BLAST-BLOCK, offers a unique and exclusive combination of energy absorbing over pressure suppression materials.

The following examples are provided to more fully illustrate some of the embodiments of the present invention. It should be appreciated by those of skill in the art that the techniques disclosed in the examples which follow represent techniques discovered by the inventors to function well in the practice of the invention, and thus can be considered to constitute exemplary modes for its practice. However, those of skill in the art should, in light of the present disclosure, appreciate that many changes can be made in the specific embodiments that are disclosed and still obtain a like or similar result without departing from the spirit and scope of the invention.

### EXAMPLES

In a typical procedure, Peak Over Pressure, by way of explanation, is the highest force or energy of a blast wave that is generated nearest to the fireball (ground zero). Peak Over Pressures are very high near the explosion but drop off rapidly as the blast zone travels along the ground outwards from ground zero.

Impulse Energy is, essentially and simply put, the amount of energy from the blast that is exerted on the target object.

It means, literally, the amount of energy it takes to move an object and cause damage that exceeds the ability of the target to resist.

The requirements desired were about 50 pounds of TNT (TNT is the standard by which all explosives are measured, very similar to engines using horsepower to measure output; even nuclear weapons are measured in force by equivalent comparisons to TNT).

As used in the examples, ANFO is ammonium nitrate fuel oil.

### Example 1

This Example serves to illustrate blast resistance of the blast protective system and method.

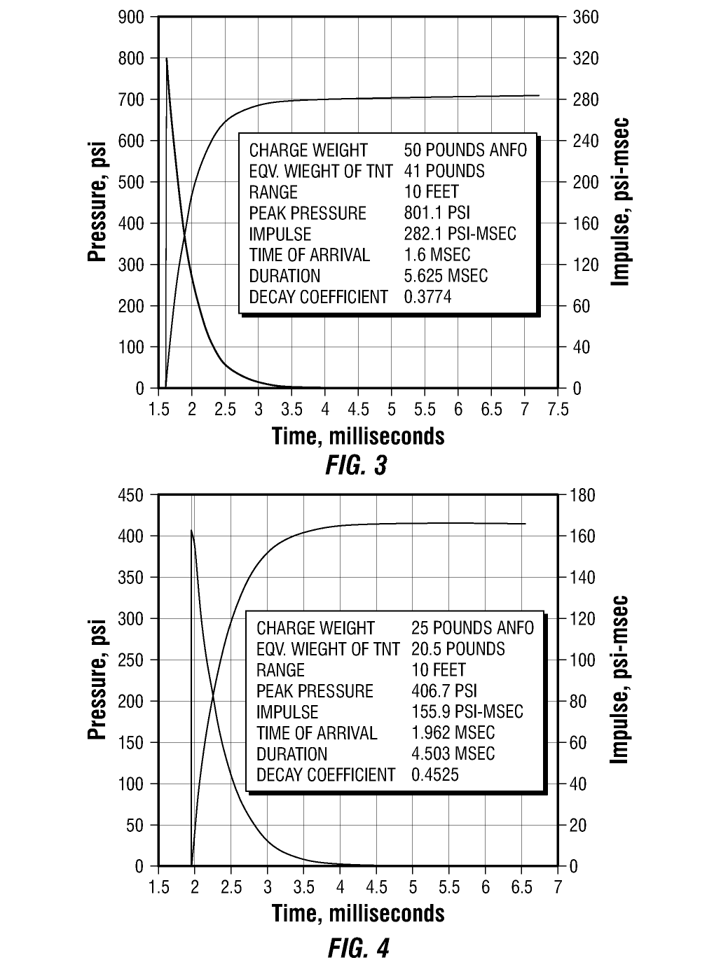

In a typical procedure, a system as depicted in FIGS. 1 and 2, as described in the accompanying description above, was applied to a pipe. The charge weight was about 50 pounds of ANFO. The equivalent weight of TNT was 41 pounds. The range was about 10 feet. The peak pressure was 801.1 psi. The impulse was 282.1 psi-msec. The time of arrival was 1.6 msec. The duration was 5.625 msec. The decay coefficient was 0.374. Pressure and impulse as a function of time, illustrating reflected pressure for a hemispherical surface burst, are depicted in FIG. 3.

### Example 2

This Example serves to further illustrate blast resistance of the blast protective system and method.

In a typical procedure, a system as depicted in FIGS. 1 and 2, as described in the accompanying description above, was applied to a pipe. The charge weight was 25 pounds of ANFO. The equivalent weight of TNT was 20.5 pounds. The range was about 10 feet. The peak pressure was 406.7 psi. The impulse was 169.9 psi-msec. The time of arrival was 1.962 msec. The duration was 4.580 msec. The decay coefficient was 0.4525. Pressure and impulse as a function of time, illustrating reflected pressure for a hemispherical surface burst, are depicted in FIG. 4.

### Example 3

This Example serves to further illustrate blast resistance of the blast protective system and method.

In a typical procedure, a system as depicted in FIGS. 1 and 2, as described in the accompanying description above, was applied to a pipe. The blast load resistance desired for a water main needed to be Peak pressure @ 52.2 psi-msec (P=defined as blast overpressure) and Impulse @ 73.7 psi (I is defined as impulse wave pressure). According to South West Research, one of the leading blast and explosive testing engineering firms in the U.S., an illustrative implementation of the invention only needed 9 pounds of TNT to achieve the requirements. In the end, WinTec exceeded the test requirements by a factor of over 15 times.

### Example 4

This Example serves to further illustrate blast resistance of the blast protective system and method.

The blast load resistance desired for a water main needed to be Peak pressure @ 52.2 psi-msec (P=defined as blast overpressure) and Impulse @ 73.7 psi (I is defined as impulse wave pressure).

In a typical procedure, a system as depicted in FIGS. 1 and 2, as described in the accompanying description above, was applied to a 6⅝ inch outer diameter steel pipe. 62.5 pounds of ANFO was used as an equivalent to about 50 pounds of TNT at a distance of 10 (ten) feet. The weather conditions were sunny and breezy. The site was mostly flat with some terrain depression, and raised elevations to the east. There were three specimens of pipe protection. Each specimen was filled with water before the test. For each, the ANFO at a 10 feet distance was exploded. The testing authority was EBI Erfurt Blasting, Inc. At the required standoff, it was not possible to achieve both the requirements of Peak pressure @ 52.2 psi-msec and Impulse @ 73.7 psi. As such the charge was sized to meet the desired impulse, while creating a much higher peak pressure. Using a 9 pound charge would results in a reflected impulse of 77 psi-msec with a peak pressure of 145 psi. Testing was 62.5 pounds of ANFO, which far exceeds the standard of Peak pressure @ 52.2 psi-msec and Impulse @ 73.7 psi at a distance of 10 feet. The diameter of each specimen was visually inspected and appeared to be undamaged. Each specimen passed, where passing indicated the steel pipe was intact and sustained no penetration or signs of water leakage.

In conclusion, the present invention provides a blast resistant system and method for protecting a pipe. The system and method provide blast resistance to at least about 50 pounds of TNT at about 10 feet distance.

All patents and publications referenced herein are hereby incorporated by reference. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise than as specifically described without actually departing from the spirit and scope of the present invention as defined by the appended claims.

What is claimed is:

1. A system for protecting a pipe, comprising:
an energy absorbing inner matrix bound to the pipe;
an outer wrap comprising fire resistant foil; and
a blast resistant material disposed between the inner matrix and the outer wrap, wherein the blast resistant material comprises Purlite.

2. The system for protecting a pipe according to claim 1, wherein the Purlite is contained in a plurality of bags.

3. The system for protecting a pipe according to claim 1, wherein the bags are arrayed circumferentially around the pipe.

4. The system for protecting a pipe according to claim 1, wherein the system is resistant to at least about 50 pounds of TNT at about 10 feet distance.

5. The system for protecting a pipe according to claim 1, wherein the energy absorbing inner matrix comprises:
a polymeric annulus; and
a pair of fiberglass half-pipes disposed over the annulus.

6. The system for protecting a pipe according to claim 5, wherein the polymeric annulus comprises first and second polymers.

7. The system for protecting a pipe according to claim 6, wherein the first polymer comprises urethane foam.

8. The system for protecting a pipe according to claim 6, wherein the second polymer comprises reticulated foam.

9. The system for protecting a pipe according to claim 6, wherein the annulus comprises an inner annulus comprising the first polymer and a second annulus comprising the second polymer.

10. The system for protecting a pipe according to claim 9, wherein the second annulus further comprises a third polymer soaked into the second polymer.

11. The system for protecting a pipe according to claim 10, wherein the first polymer comprises urethane foam, the second polymer comprises reticulated foam, and the third polymer comprises urethane.

12. The system for protecting a pipe according to claim 1, wherein the inner matrix comprises a blast resistant window film.

13. The system for protecting a pipe according to claim 1, wherein the inner matrix comprises ballistic film.

14. The system for protecting a pipe according to claim 1, wherein the inner matrix comprises steel wire.

15. The system for protecting a pipe according to claim 1, wherein the inner matrix comprises a clamp.

16. A system for protecting a pipe, comprising:
an energy absorbing inner matrix bound to the pipe, wherein the energy absorbing inner matrix comprises:
a first annulus comprising urethane foam;
a second annulus disposed around the first annulus, the second annulus comprising reticulating foamed soaked in urethane;
a pair of fiberglass half-pipes disposed over the second annulus;
a blast resistant window film disposed over the half-pipes;
a ballistic film disposed over the blast resistant window film;
steel wire disposed over the ballistic film; and
a clamp;
an outer wrap comprising fire resistant foil; and
a blast resistant material disposed between the inner matrix and the outer wrap, wherein the blast resistant material comprises a Purlite contained in a plurality of bags arranged circumferentially around the pipe,
wherein the system is resistant to at least about 50 pounds of TNT at about 10 feet distance.

17. A method for protecting a pipe, comprising:
binding an energy absorbing inner matrix to the pipe;
disposing Purlite around the inner matrix;
wrapping the Purlite with fire resistant foil.

18. The method for protecting a pipe according to claim 17, wherein the disposing comprises:
providing the Purlite in a plurality of bags.

19. The method for protecting a pipe according to claim 18, wherein the providing comprises arranging the bags circumferentially around the pipe.

20. The method for protecting a pipe according to claim 17, wherein the method provides protection of the pipe from at least about 50 pounds of TNT at about 10 feet distance.
